(19) United States
(12) Patent Application Publication
(10) Pub. No.: US 2020/0107112 A1
(43) Pub. Date: Apr. 2, 2020

(54) SINGLE-MAGNET DOUBLE-TONE-CIRCUIT COAXIAL LOUDSPEAKER

(71) Applicant: Tymphany Acoustic Technology (Huizhou) Co., Ltd., Huizhou City (CN)

(72) Inventors: TUNG-KO James LU, Huizhou City (CN); HSIN-HUNG KU, Huizhou City (CN)

(21) Appl. No.: 16/587,999

(22) Filed: Sep. 30, 2019

Related U.S. Application Data
(60) Provisional application No. 62/738,312, filed on Sep. 28, 2018.

(51) Int. Cl. H04R 1/28; H04R 9/06

(52) U.S. Cl. CPC H04R 1/2819; H04R 2209/024; H04R 9/06

(57) ABSTRACT

A single-magnet double-tone-circuit coaxial loudspeaker includes a shell, a U iron, a magnet, a spring washer, a first diaphragm assembly, a second diaphragm assembly, an upper cover and a terminal plate. A single “magnet+spring washer+U iron” magnetic circuit is extended to be two upper-lower coaxial magnetic circuits, therefore, the first diaphragm assembly and the second diaphragm assembly which are electrically connected to the terminal plate generate a double-magnetic-circuit feature by sharing a single-magnet system. High frequency and low frequency wave bands are driven independently, such that high frequency and low frequency portions can achieve a better sound resolution effect. The complementation of the two reduces distortion, thus improves the overall acoustic performance of the loudspeaker.

### CROSS REFERENCE TO RELATED APPLICATIONS

This application claims priority to U.S. Provisional Application No. 62/738,312, which was filed on Sep. 28, 2018, and which is herein incorporated by reference.

### TECHNICAL FIELD

The present invention relates to the technical field of loudspeaker manufacturing, in particular to a single-magnet double-tone-circuit coaxial loudspeaker.

### BACKGROUND ART

In a moving coil speaker, when an electrical signal applied on a voice coil producing an induced magnetic field, the induced magnetic field can correspondingly react to the magnetic field of a permanent magnet that causes magnetic flux density change driving the vibration of a diaphragm. This is called “electricity-sound conversion function”.

The conventional moving coil loudspeaker is generally a single-magnetic-circuit design. Such single magnetic circuit system comprises a single diaphragm and a single voice coil. The electricity-sound conversion function is accomplished by the vibration of one diaphragm which expectedly produces the entire audible spectrum. But, such single-magnetic-circuit design cannot give consideration to the frequency widths of both treble and bass. In order to achieve a bass effect, the film of the diaphragm and a suspension system should be flexible. On the contrary, in order to achieve a treble effect, the film of the diaphragm should have a rigid structure.

Thus, in high end acoustic apparatus, to perform good quality sound no matter at low frequency and high frequency, a coaxial speaker is the solution. The coaxial speaker composes of two transducer units (generally a woofer and a tweeter) which are mechanically coupled and share the same central acoustic axis. Since the two transducer units are on the same axis and the physical positions thereof approximate to a point sound source, the sound field for re-playing music is positioned ideally, and the sound resolution is high. However, such a structure requires two magnetic circuit systems, which would increase the volume and thickness of the loudspeaker, and does not satisfy the requirements for the development trend of ultra-thin loudspeakers at present.

### SUMMARY OF THE INVENTION

In order to solve the above-described problems, the present invention provides a single-magnet double-tone-circuit coaxial loudspeaker (or called “coaxial dual voice coil loudspeaker”). On the basis of the structure of a single-magnet system, the two diaphragm assemblies are respectively used for treble and bass, and gives consideration to the frequency widths of both treble and bass The complementation of the two reduces distortion, thus improving the overall acoustic performance of the loudspeaker.

To achieve the above object, the present invention provides a single-magnet double-tone-circuit coaxial loudspeaker, including shell, forming an installation chamber therein,a U iron, disposed in the installation chamber and provided with a first hole, a magnet, disposed above the U iron, and provided with a second hole, a spring washer, having a T-shaped structure, and comprising an annular portion and a columnar portion, the columnar portion penetrating through the second hole and the first hole, and the annular portion being disposed above the magnet. A first diaphragm assembly is disposed above the installation chamber, and includes a first diaphragm and a first voice coil which are connected together, the first voice coil being sleeved outside the annular portion. A second diaphragm assembly, disposed below the installation chamber, and includes a second diaphragm and a second voice coil which are connected together, the second voice coil being sleeved outside the columnar portion.

As a preferred technical solution, the bottom surface of the columnar portion is flush with the bottom surface of the U iron.

As a preferred technical solution, the first diaphragm comprises a first main body portion and a first peripheral portion radiating from the first main body portion, wherein the first peripheral portion presses against the inner side of the shell.

As a preferred technical solution, the second diaphragm comprises a second main body portion and a second peripheral portion radiating from the second main body portion, wherein the second peripheral portion presses against the bottom surface of the U iron.

As a preferred technical solution, the first diaphragm is a bass diaphragm, and the second diaphragm is a treble diaphragm or a bass diaphragm.

As a preferred technical solution, the first diaphragm is larger than the second diaphragm.

As a preferred technical solution, the first voice coil is bigger than the second voice coil.

As another preferred technical solution, the first diaphragm is a treble diaphragm, and the second diaphragm is a bass diaphragm.

As a preferred technical solution, the coaxial loudspeaker further comprises an upper cover, wherein the upper cover is disposed above the first diaphragm assembly, is fixedly connected to the shell, and is provided with holes.

As a preferred technical solution, the holes are disposed on the top surface or side surface of the upper cover.

As a preferred technical solution, a terminal base is disposed on the outer side of the shell. A terminal plate is installed on the terminal base, and is electrically connected to the first voice coil and the second voice coil.

On the basis of the above-described technical solution, the present invention achieves the following technical effects:

(1) In the single-magnet double-tone-circuit coaxial loudspeaker of the present invention, one of features is two sets of diaphragm assembly. The first diaphragm assembly and the second diaphragm assembly are disposed in opposite and use the common magnetic system of “a magnet+a T-shaped spring washer+a U iron”, so as to form two magnetic circuits.

By such design, the loudspeaker can perform better sound quality in both treble and bass, and achieve a better sound parsing effect, because this design can independently perform driving in high frequency and low frequency bands. Moreover, the simple structure of such coaxial loudspeaker can have the advantages of easy assembly, as well as light weight and small volume of the loudspeaker. This is also the current trend of developing ultra thin loudspeaker.

(2) In the single-magnet double-tone-circuit coaxial loudspeaker of the present invention, the first voice coil and the second voice coil are respectively electrically connected to the terminal plate; high frequency and low frequency wave bands can be driven independently, such that high frequency and low frequency portions can achieve a better sound resolution effect. In addition, a frequency divider can be connected to a treble unit (treble diaphragm assembly) to avoid from energy loss due to intermediate frequency interference, so as to achieve treble and bass complementation, reduce distortion, and improve assembly frequency response. It thus improves the overall acoustic performance of the loudspeaker.

(3) In the single-magnet double-tone-circuit coaxial loudspeaker of the present invention, an upper cover with holes arrangement is disposed on the shell, more specifically, the upper cover disposed outside of bass diaphragm. This design can purify bass output, so as to achieve a physical frequency division effect and also adjust the damping effect of the loudspeaker.

### BRIEF DESCRIPTION OF THE DRAWINGS

FIG. 1 is an exploded view of the single-magnet double-tone-circuit coaxial loudspeaker according to the present invention;

FIG. 2 is a sectional view of the single-magnet double-tone-circuit coaxial loudspeaker according to the present invention;

FIG. 3 is a local sectional view of the single-magnet double-tone-circuit coaxial loudspeaker according to the present invention;

FIG. 4 is a finished product assembly diagram of the single-magnet double-tone-circuit coaxial loudspeaker from one visual angle according to the present invention;

FIG. 5 is a finished product assembly diagram of the single-magnet double-tone-circuit coaxial loudspeaker from another visual angle according to the present invention; and

FIG. 6 is an assembly frequency curve comparison diagram of the single-magnet double-tone-circuit coaxial loudspeaker of the present invention and a conventional single-magnetic circuit system loudspeaker.

### DETAILED DESCRIPTION OF THE EMBODIMENTS

In order to understand the present invention conveniently, the present invention will be described more completely in combination with the accompanying drawings and specific embodiments. Preferred embodiments of the present invention are given in the accompanying drawings. However, the present invention may be implemented in many different forms, and is not limited to the embodiments described herein. On the contrary, these embodiments are provided to understand the contents of the present invention more thorough and complete.

It is to be noted that when one element is referred to as being “fixed” to other element, it may be directly on the other element or an intervening element may also be present. When one element is considered as being “connected” to the other element, it may be directly connected to the other element or an intervening element may be present simultaneously.

Unless otherwise defined, all technical and scientific terms used herein have the same meaning as commonly understood by one of ordinary skill in the art. The terms used in the specification of the present invention are merely for describing the specific embodiments and are not intended to limit the present invention.

### Embodiment 1

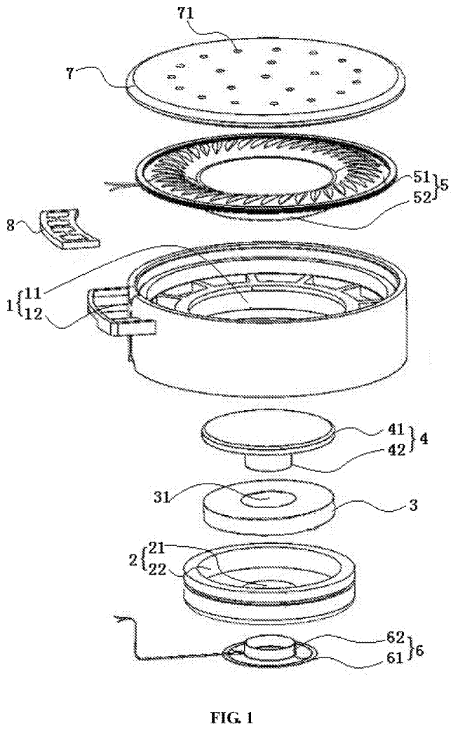

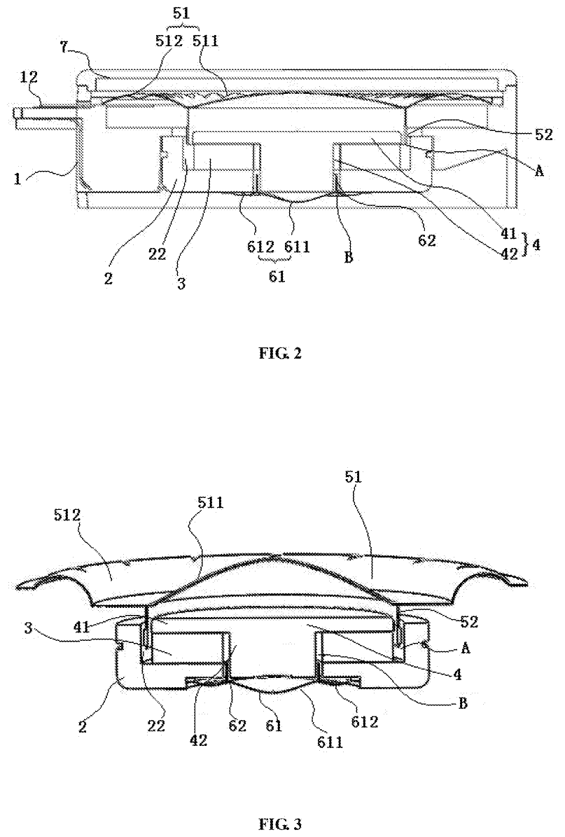

FIG. 1 depicts an exploded view of the single-magnet double-tone-circuit coaxial loudspeaker according to the embodiment and FIG. 2 depicts a sectional view of the single-magnet double-tone-circuit coaxial loudspeaker according to the embodiment. With reference to both FIGS. 1 and 2, a single-magnet double-tone-circuit coaxial loudspeaker includes a shell 1, a U iron 2, a magnet 3, a spring washer 4, a first diaphragm assembly 5, a second diaphragm assembly 6, an upper cover 7 and a terminal plate 8. The shell 1 as the main frame of the loudspeaker, is made from a plastic member. The shell 1 is a columnar structure and forms an installation chamber 11 therein. The installation chamber 11 is used to accommodate and install the other components of the loudspeaker, for example, a magnetic circuit system, a vibration system and the like. In order to cooperate with the components, the installation chamber 11 can also be correspondingly provided with a support. A terminal base 12, mainly for installing the terminal plate 8, is disposed on the outer side of the shell 1. The terminal base 12 can be fixedly installed on the outer side wall of the shell 1 and can also be integrally injection-molded with the main body of the shell 1.

The single-magnet double-tone-circuit coaxial loudspeaker of the embodiment is an inner magnet loudspeaker. That is, the magnetic circuit system of the loudspeaker adopts the magnet combination mode of “U iron+magnet+spring washer”. To be specific, the U iron 2, as a component of an added internal magnetic field, is disposed in the installation chamber 11, and is located below the shell 1. As shown in FIG. 1, the U iron 2 has a bowl-shaped structure and includes a first hole 21 on the bottom of the bowl-shaped structure and forms an accommodation chamber 22 above the bottom.

As a magnetic field generation component, the magnet 3 has an annular structure, is disposed above the U iron 2, and is located in the accommodation chamber 22. The magnet 3 includes a second hole 31. A hole diameter of the second hole 31 approximates to that of the first hole 21. The magnet 3 can be made from a neodymium-iron-boron magnet or a ferrite magnet.

The spring washer 4 of the embodiment has a T-shaped structure and comprises an upper annular portion 41 and a lower columnar portion 42, wherein the columnar portion 42 is disposed in the middle of the annular portion 41. The annular portion 41 and the columnar portion 42 can be an integrated structure and can also form the entire T-shaped spring washer structure in the fixation manner of bonding, welding and the like. The spring washer 4 is stacked on the magnet 3. To be specific, the columnar portion 42 penetrates through the second hole 31 and the first hole 21, and the annular portion is disposed above the magnet 3. In the embodiment, the bottom surface of the columnar portion 42 is flush with the bottom surface of the U iron 2. In other embodiments, the bottom surface of the columnar portion 42 can be configured to be lower than the bottom surface of the U iron, which can be designed according to the requirements for the component accommodation structure.

FIG. 3 depicts a local sectional view of the single-magnet double-tone-circuit coaxial loudspeaker according to the present invention. The drawing presents the connecting structure of the U iron, the magnet and the spring washer from another angle. With reference to both FIGS. 2 and 3, the single-magnet system of “U iron+magnet+T-shaped spring washer” in the embodiment has two magnetic gaps as follows: a first magnetic gap A formed between the inner wall of the accommodation chamber 22 and the outer wall of the magnet 3 as well as the outer wall of the annular portion 41, and a second magnetic gap B formed between the inner wall of the first hole 21, the inner wall of the second hole 31 and the outer wall of the columnar portion 42.

Still further with reference to FIG. 1, the first diaphragm assembly 5 is disposed above the installation chamber 11. The first diaphragm assembly 5 comprises a first diaphragm 51 and a first voice coil 52, wherein the first diaphragm 51 and the first voice coil 52 are fixedly connected together. Furthermore, one end of the first voice coil 52 penetrates through the first magnetic gap A and the first voice coil 52 is sleeved outside the annular portion 41. The second diaphragm assembly 6 is disposed below the installation chamber 11. The second diaphragm assembly 6 comprises a second diaphragm 61 and a second voice coil 62, wherein the second diaphragm 61 and the second voice coil 62 are also fixedly connected together.

Furthermore, one end of the second voice coil 62 penetrates through the second magnetic gap B, and the second voice coil 62 is sleeved outside the columnar portion 42.

The first diaphragm 51 comprises a first main body portion 511 and a first peripheral portion 512. The first peripheral portion 512 radiates from the first main body portion 511, and is provided with wrinkles on the surface thereof. The wrinkles can improve the stiffness of the first diaphragm, thus facilitating the improvement of the vibration frequency of the first diaphragm. In the embodiment, the first peripheral portion 512 presses against the inner side of the shell 1.

The second diaphragm 61 comprises a second main body portion 611 and a second peripheral portion 612, wherein the second peripheral portion 612 radiates from the second main body portion 611, and presses against the bottom surface of the U iron 2.

In the loudspeaker of the embodiment, the spring washer is a T-shaped spring washer, and comprises an upper annular portion 41 and a lower columnar portion 42.

The first diaphragm assembly 5 is disposed above the annular portion 41. The second diaphragm assembly 6 is disposed below the columnar portion 42. Therefore, in the single-magnet system of the embodiment, a single magnetic circuit is extended to be two upper-lower coaxial magnetic circuits. The first diaphragm assembly and the second diaphragm assembly generate a double-magnetic-circuit feature by sharing the single-magnet system, thus giving consideration to the frequency widths of both treble and bass, and reducing the overall weight and volume of the loudspeaker.

In a specific implementation process, the first diaphragm is configured to be a bass diaphragm, and can adopt the materials of paper, carbon fiber, ballistic fabric, rubber and the like, so as to facilitate bass reproduction. The diameter thereof can be set as 40 mm. The second diaphragm is configured to be a treble diaphragm, and can adopt an aluminum film, a titanium film or an indium film as a diaphragm material; the diameter thereof can be set as 15 mm. That is, the first diaphragm 51 is larger than the second diaphragm 61. Correspondingly, the first voice coil 52 is also bigger than the second voice coil 62.

In other embodiments, as a variation, the loudspeaker can also be configured wherein the first diaphragm is a treble diaphragm, and the second diaphragm is a bass diaphragm. When the loudspeaker sounds, the vibration amplitude of the treble diaphragm is small, and the vibration amplitude of the bass diaphragm is great. A frequency divider can be used to transmit high frequency signals to the treble diaphragm, and low frequency signals to the bass diaphragm, treble and bass signals are transmitted via different channels, and the complementation of the two reduces the distortion of the loudspeaker.

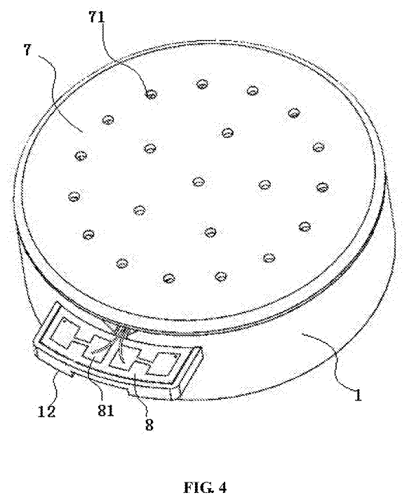

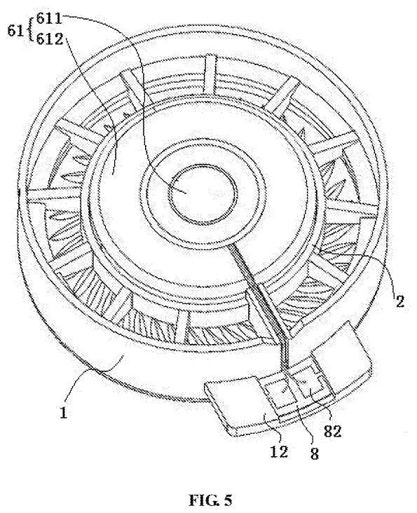

FIG. 4 depicts a finished product assembly diagram of the single-magnet double-tone-circuit coaxial loudspeaker from one visual angle according to the present invention and FIG. 5 depicts a finished product assembly diagram from another visual angle. With reference to both FIGS. 4 and 5, the upper cover 7 is fixedly installed on the shell 1, and is provided with holes 71. The holes 71 are located above the first diaphragm assembly 5 and provide a damping action for the first diaphragm.

In the single-magnet double-tone-circuit coaxial loudspeaker, when the first diaphragm is a bass diaphragm and the second diaphragm is a treble diaphragm, the treble diaphragm outputs from the front face, and the bass diaphragm is controlled under the damping action of the upper cover, and outputs from the rear face. Such utilization of the physical frequency division principle enables the output of sound to achieve a treble-bass complementation effect, and enables the assembly frequency of the loudspeaker to achieve an ideal frequency response.

The diameter size, number and arrangement mode of the holes 71 can he adjusted according to requirements, for example, the holes 7.1 can be disposed on the top surface of the upper, or on the side surface of the upper cover, or on the top surface and side surface both. The holes 71 can be arranged in an annular shape or in a radiating shape. In addition, an adjustment plate can be further added. A plurality of holes are also correspondingly disposed on the adjustment plate. The adjustment plate is stacked on the upper cover, and can be rotated to adjust the hole coverage or penetration situation of the upper cover, so as to achieve a damping adjustment effect.

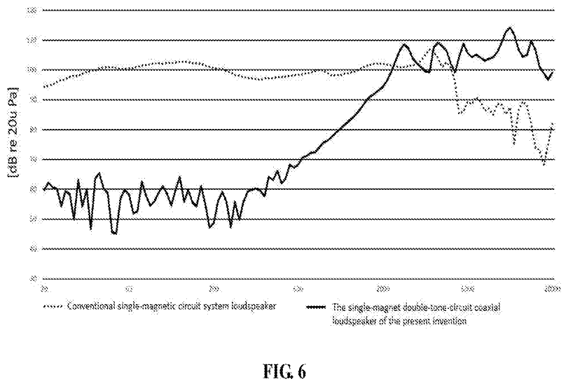

Further with reference to FIGS. 4 and 5, the terminal plate 8 is installed on the terminal base 12 on the outer side of the shell. An upper electrode 81 is disposed above the terminal plate 8. A lower electrode 82 is disposed below the terminal plate. The first voice coil 52 is electrically connected the upper electrode 81. The second voice coil 62 is electrically connected to the lower electrode 82. Therefore, the first voice coil and the second voice coil are both electrically connected to the terminal plate 8. Low frequency and high frequency wave bands can be driven independently, such that low frequency and high frequency portions can achieve a better sound resolution effect. The complementation of the two reduces distortion, thus improving the overall acoustic performance of the loudspeaker. The sound output effect of the single-magnet double-tone-circuit coaxial loudspeaker in the embodiment is as shown in the assembly frequency curve diagram in FIG. 6. Compared to the conventional single-magnetic circuit system loudspeaker, the single-magnet double-tone-circuit coaxial loudspeaker in the embodiment gives consideration to the frequency widths of both treble and bass, and achieves an ideal assembly frequency response.

The above contents are merely examples and explanations for the structure of the present invention, and the description is specific and detailed but cannot be accordingly understood as limits to a patent scope of the present invention. It should be pointed out those of ordinary skill in the art may further make a plurality of variations and improvements without departing from the concept of the present invention, and these apparent replacement forms all pertain to the protection scope of the present invention.

1. A single-magnet double-tone-circuit coaxial loudspeaker, comprising:
a shell having an installation chamber therein;
a U-iron disposed in the installation chamber and having a first hole;
a magnet, disposed above the U iron, and having a second hole;
a spring washer, having a T-shaped structure, and comprising:
an annular portion disposed above the magnet; and
a columnar portion penetrating through the second hole and the first hole;
a first diaphragm assembly, disposed above the installation chamber, and comprising:
a first diaphragm; and
a first voice coil sleeved outside the annular portion and connected to the first diaphragm; and
a second diaphragm assembly, disposed below the installation chamber, and comprising:
a second diaphragm; and
a second voice coil sleeved outside the columnar portion and connected to the second diaphragm.

2. The single-magnet double-tone-circuit coaxial loudspeaker according to claim 1, wherein a bottom surface of the columnar portion is flush with a bottom surface of the U iron.

3. The single-magnet double-tone-circuit coaxial loudspeaker according to claim I, wherein the first diaphragm comprises:
a first main body portion; and
a first peripheral portion radiating from the first main body portion and pressing against an inner side of the shell.

4. The single-magnet double-tone-circuit coaxial loudspeaker according to claim 1, wherein the second diaphragm comprises:
a second main body portion; and
a second peripheral portion radiating from the second main body portion and pressing against a bottom surface of the U iron.

5. The single-magnet double-tone-circuit coaxial loudspeaker according to claim 1, wherein the first diaphragm is a bass diaphragm and the second diaphragm is a treble diaphragm.

6. The single-magnet double-tone-circuit coaxial loudspeaker according to claim 5, wherein the first diaphragm is larger than the second diaphragm.

7. The single-magnet double-tone-circuit coaxial loudspeaker according to claim 6, wherein the first voice coil is larger than the second voice coil.

8. The single-magnet double-tone-circuit coaxial loudspeaker according to claim 1, wherein the first diaphragm is a treble diaphragm and the second diaphragm is a bass diaphragm.

9. The single-magnet double-tone-circuit coaxial loudspeaker according to claim 1, further comprising an upper cover, disposed above the first diaphragm assembly and being fixedly connected to the shell, including a plurality of holes.

10. The single-magnet double-tone-circuit coaxial loudspeaker according to claim 9, wherein the plurality of holes is disposed on a top surface or a side surface of the upper cover.

11. The single-magnet double-tone-circuit coaxial loudspeaker according to claim 1, further comprising:
a terminal base disposed on an outer side of the shell; and
a terminal plate installed on the terminal base and electrically connected to the first voice coil and the second voice coil.
